(19) United States
(12) Patent Application Publication
(10) Pub. No.: US 2026/0054628 A1
(43) Pub. Date: Feb. 26, 2026

(54) SEATBACK USING AIR POCKET

(71) Applicant: HYUNDAI TRANSYS INC., Seosan-si (KR)

(72) Inventors: Gu Chang KANG, Hwaseong-si (KR); Ui Jeong LEE, Hwaseong-si (KR); Jae Hyun PARK, Hwaseong-si (KR); Ki Jung PARK, Hwaseong-si (KR)

(21) Appl. No.: 19/279,422

(22) Filed: Jul. 24, 2025

(30) Foreign Application Priority Data
Aug. 26, 2024 (KR) 10-2024-0114083

(51) Int. Cl. B60N 2/90; A61H 9/00; B60N 2/58

(52) U.S. Cl. CPC B60N 2/976; A61H 9/0078; B60N 2/58; A61H 2201/0149; A61H 2201/1623; A61H 2203/0431; A61H 2205/081

(57) ABSTRACT

The seatback may include a seatback cover, a seatback pad configured to support the seatback cover, the seatback pad including an open spaced formed therein, a first air pocket disposed in the open space, the first air pocket including a plurality of ventilation holes provided therein, and a second air pocket disposed on the first air pocket, the second air pocket including a flow path provided thereon, the flow path configured to be in communication with the ventilation holes.

### CROSS-REFERENCE TO RELATED APPLICATION

This application claims priority, under 35 U.S. C. § 119(a), to Korean Patent Application No. 10-2024-0114083, filed on Aug. 26, 2024, the entire contents of which are incorporated herein by reference.

### BACKGROUND

### (a) Technical Field

The present disclosure relates to a seatback capable of utilizing an air pocket to support the back of a passenger and implementing ventilation performance of a seat.

### (b) Background Art

In the automotive industry, a seat is an important component having the largest contact area with a passenger. Depending on the physical properties of a pad constituting a seat, a passenger may experience different levels of seating comfort when sitting on the seat. Even if passengers sit on the same seat, the passengers may experience different levels of seating comfort. In general, a pad applied to a seat is designed in consideration of the amount of pressing and sagging caused by pressure applied to the seat when a passenger sits on the seat. The thickness of a seat is determined to be 30 mm to 60 mm. Here, the larger thickness a seat is designed to have, the more comfortable seating the passenger may experience.

However, a seat to which a general pad is applied has a structure in which a passenger cannot adjust the level of seating comfort according to different needs of the passenger. That is, even if a passenger desires soft seating, the passenger cannot directly adjust the thickness of a pad constituting a seat.

Meanwhile, recently, a massage module capable of massaging the passenger's body has been installed in a seat of a luxury vehicle. However, there is a drawback in that, if a thick pad is applied to a seat so as to provide soft seating to a passenger, a massage effect by the massage module deteriorates due to the thick pad.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a seatback using an air pocket capable of realizing seating comfort desired by a passenger.

It is another aspect of the present disclosure to provide a seatback capable of utilizing an air pocket to support the back of a passenger and implementing ventilation performance of a seat.

It is still another aspect of the present disclosure to provide a seatback using an air pocket, configured to prevent deterioration in the effect of a massage module due to the air pocket when the massage module is activated.

In one aspect, the present disclosure provides a seatback including a seatback cover, a seatback pad configured to support the seatback cover, wherein the seatback pad includes an open space formed therein, a first air pocket disposed in the open space, the first air pocket includes a plurality of ventilation holes provided therein, and a second air pocket disposed on the first air pocket, the second air pocket including a flow path provided thereon and the flow path configured to be in communication with the ventilation holes.

In a preferred embodiment, the flow path may be provided on a first surface of the second air pocket, the second air pocket may include an inlet provided a second surface thereof, wherein air is to be injected into the flow path through the inlet, and the first surface of the second air pocket may be oriented to face the first air pocket.

In another preferred embodiment, the first air pocket and the second air pocket may be made of thermoplastic polyurethane or polyvinyl chloride.

In still another preferred embodiment, the seatback may include a massage module disposed on the second air pocket, and a controller configured to control an amount of air injected into the first air pocket and the second air pocket.

In yet another preferred embodiment, the controller may be configured to, based on the massage module being activated, control the amount of the air injected into the first air pocket and the second air pocket to a preset minimum value.

In still yet another preferred embodiment, the controller may be configured to, in response to input of a request to lower of an intensity level of the massage module, control the amount of the air injected into the first air pocket and the second air pocket to be increased above the preset minimum value.

In a further preferred embodiment, the controller may be configured to, based on the massage module being in a non-activated state, control the amount of the air injected into the first air pocket and the second air pocket to be maintained at a preset average value.

In another further preferred embodiment, the seatback may include an airbag inflator provided between the first air pocket and the second air pocket, and the controller may be configured to operate the airbag inflator based on a vehicle collision signal received from a vehicle controller.

In still another further preferred embodiment, the seatback may further include a wire connected to the seatback pad, and a plurality of hog rings configured to connect the first air pocket and the second air pocket to the wire.

In yet another further preferred embodiment, the seatback may further include a blower configured to inject air into the first air pocket, the second air pocket, and the flow path.

In another aspect, the present disclosure provides a seatback including a seatback cover, a seatback pad configured to support the seatback cover, the seatback pad including an open space formed therein, an air pocket disposed in the open space of the seatback pad, the air pocket configured to support a back of a passenger, a massage module disposed on the air pocket, and a controller configured to control an amount of air injected into the air pocket based on whether the massage module is activated.

In a preferred embodiment, the air pocket may include a first air pocket disposed on a frame of the seatback, the first air pocket including a plurality of through-holes provided therein, and a second air pocket disposed on the first air pocket, the second air pocket including a flow path provided thereon, the flow path configured to be in communication with the through-holes, the first air pocket may be disposed on a first surface of the second air pocket, and the massage module may be disposed on a second surface of the second air pocket, the second surface being opposite the one surface of the second air pocket.

In another preferred embodiment, the controller may be configured to, based on the massage module being in a non-activated state, control the amount of the air injected into the air pocket to be maintained at a preset average value.

In still another preferred embodiment, the controller may be configured to, based on the massage module being in an activated state, control the air injected into the air pocket to be discharged for a preset first time period.

In yet another preferred embodiment, the preset first time period may be set to vary depending on a preset intensity level of the massage module, and the preset first time period may be set to become shorter as the preset intensity level becomes lower.

In still yet another preferred embodiment, the controller may be configured to, based on operation of the massage module being terminated, control the air injected into the air pocket for a preset second time period so as to adjust the amount of the air injected into the air pocket to the preset average value.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing a seatback according to an embodiment of the present disclosure;

FIG. 2 is a cross-sectional view taken along line A-A′ in FIG. 1;

FIG. 3 is a cross-sectional view taken along line B-B′ in FIG. 1;

FIG. 4 is a view showing an air pocket according to an embodiment of the present disclosure;

FIG. 5 is a view showing a second air pocket according to an embodiment of the present disclosure;

FIG. 6 is a view for description of a position at which a wire according to an embodiment of the present disclosure is disposed in the seatback;

FIG. 7 is a view showing the air pocket in a state in which a massage module according to an embodiment of the present disclosure is activated;

FIG. 8 is a view showing the air pocket in a state in which the massage module according to the embodiment of the present disclosure is not activated;

FIG. 9 is a view for description of a function of a controller according to an embodiment of the present disclosure; and

FIG. 10 is a view for description of a method of controlling the air pocket according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Advantages and features of the present disclosure and a method of achieving the same will become more apparent with reference to the embodiments described below in detail and the accompanying drawings. However, the present disclosure is not limited by the embodiments disclosed below, and may be implemented in various forms. The embodiments are provided to ensure that the disclosure of the present disclosure is complete, and to fully inform the scope of the disclosure to those skilled in the art to which the present disclosure pertains, and the present disclosure is only defined by the scope of the claims. In the drawings, the same reference numerals refer to the same or equivalent components of the present disclosure throughout the specification.

Terms such as “part”, “unit”, and “module” described in the specification mean a unit configured to process at least one function or operation, and the unit may be implemented by hardware or software or a combination of hardware and software.

Meanwhile, in this specification, terms such as “first” and “second” are used to describe various components having the same names, and the terms are used only for the purpose of distinguishing one component from other components. The components are not limited by the terms in the following description.

The present disclosure has been described in detail with reference to preferred embodiments thereof, and the present disclosure may be used in various other combinations, modifications, and environments. That is, it will be appreciated by those skilled in the art that changes and corrections may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

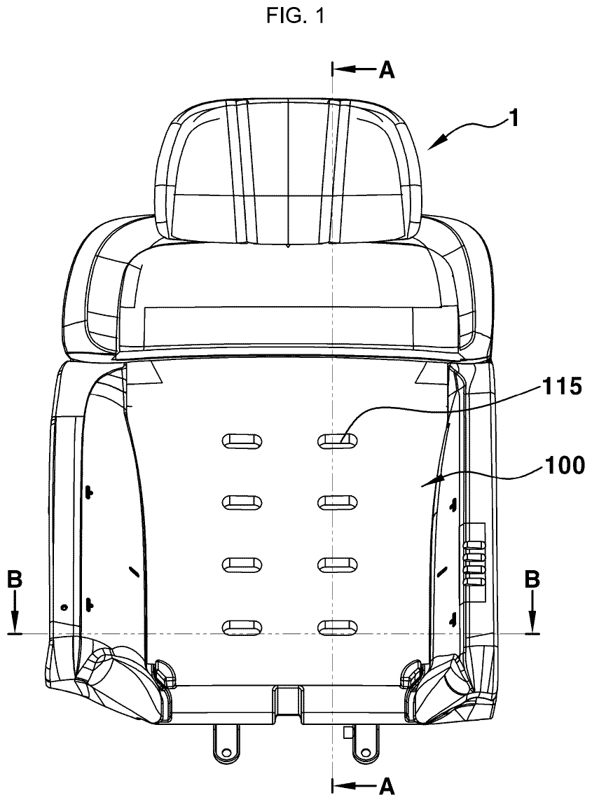

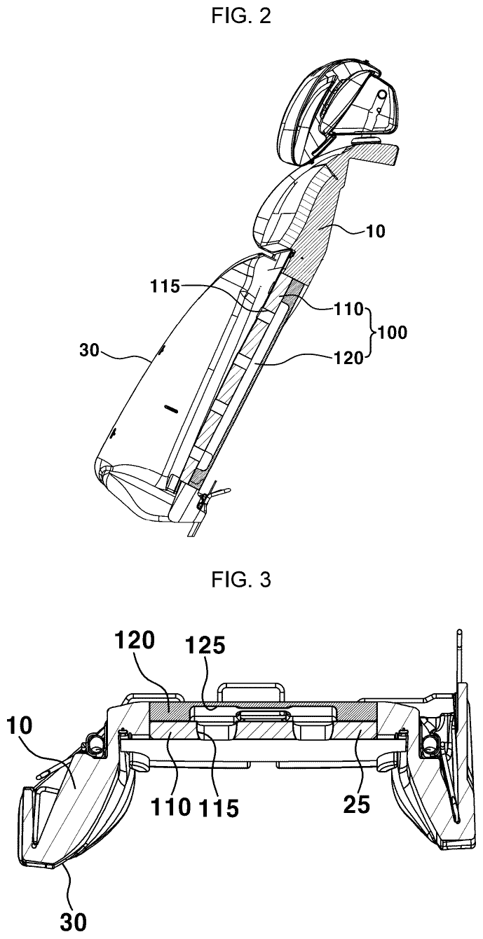

FIG. 1 is a view showing a seatback according to an embodiment of the present disclosure, and FIG. 2 is a cross-sectional view taken along line A-A′ in FIG. 1, and FIG. 3 is a cross-sectional view taken along line B-B′ in FIG. 1.

Referring to FIGS. 1 to 3, a seatback 1 may include a seatback pad 10 supporting the seatback and an air pocket 100 disposed in an open space 25 provided in the seatback pad 10. The seatback cover 30 may cover both the seatback pad 10 and the air pocket 100.

The seatback pad 10 may support the seatback excluding a space having the air pocket 100 provided therein. The seatback pad 10 may be provided as a foam manufactured using a foaming process. For example, the seatback pad 10 may be a foam made of a combination of toluene diisocyanate (TDI) and methylene diphenyl diisocyanate (MDI).

The air pocket 100 may be disposed in the open space 25 to support the back of a passenger sitting on a seat. In a general seat, a foam pad may support the back of a passenger, but in the seatback 1 according to the embodiment of the present disclosure, the air pocket 100 may support the back of a passenger instead of the foam pad. For example, the air pocket 100 may be made of thermoplastic polyurethane (TPU) and polyvinyl chloride (PVC) which are elastic and flexible materials.

The air pocket 100 may include a first air pocket 110 and a second air pocket 120. The second air pocket 120 and the first air pocket 110 may be sequentially disposed in a direction toward a position at which a passenger sits on a seat. The first air pocket 110 may include a plurality of ventilation holes 115 capable of discharging air in a direction toward the back of the passenger. The second air pocket 120 may have a flow path 125 formed therein and configured to communicate with the ventilation holes 115. In the first air pocket 110 or the second air pocket 120, the ventilation holes 115 and the flow path 125 may be disposed to overlap each other in the direction toward the position at which the passenger sits on the seat.

According to the embodiment of the present disclosure, the air pocket 100 is used to replace the existing component supporting the back of a passenger, thereby easily implementing seating comfort desired by a passenger through control of the amount of air injected into the air pocket 100.

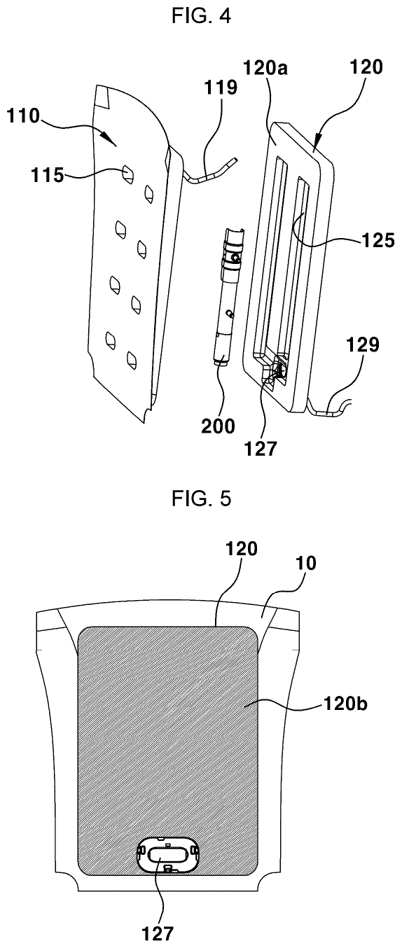

FIG. 4 is a view showing the air pocket according to the embodiment of the present disclosure, and FIG. 5 is a view showing the second air pocket according to the embodiment of the present disclosure.

Referring to FIGS. 4 and 5, the first air pocket 110 may include the plurality of ventilation holes 115. The second air pocket 120 may include the flow path 125. The ventilation holes 115 may be formed to penetrate the first air pocket 110, but the flow path 125 may be formed not to penetrate the second air pocket 120. The flow path 125 may be formed to overlap all of the plurality of ventilation holes 115. For example, the flow path 125 may be formed to have a “U” shape in one surface 120a of the second air pocket 120. An inlet 127 through which air is injected into the flow path 125 may be provided in the other surface 120b which is a surface opposite to the one surface 120a of the second air pocket 120. The one surface 120a of the second air pocket 120 may be a surface facing the first air pocket 110. The inlet 127 may be provided the other surface 120b of the second air pocket 120. Air introduced through the inlet 127 may flow to the flow path 125. Here, air flowing through the flow 125 may be discharged to the outside of the air pockets 110 and 120 through the ventilation holes 115.

The first air pocket 110 may receive air through a first line 119, and the second air pocket 120 may receive air through a second line 129. A duct (not shown) for air injection may be connected to the inlet 127. The first line 119, the second line 129, and the duct (not shown) may be connected to one blower (not shown).

An airbag inflator 200 may be disposed between the first air pocket 110 and the second air pocket 120. The airbag inflator 200 may be connected to at least one of the first air pocket 110 or the second air pocket 120. The airbag inflator 200 may be operated when vehicle collision is predicted or vehicle collision is detected. When the airbag inflator 200 is operated, air may be instantaneously injected into the air pockets 110 and/or 120 at a pressure of up to 1.4 bar. Accordingly, injury to the back of the passenger due to a massage module (not shown) may be prevented by the first air pocket 110 and the second air pocket 120 maximally inflated between the massage module (not shown) to be described below and the back of the passenger.

According to the embodiment of the present disclosure, a pad adapted to support the back of the passenger may be replaced with the air pockets 110 and 120, and ventilation performance of the seat may be implemented through the ventilation holes 115 and the flow path 125 respectively formed in the air pockets 110 and 120.

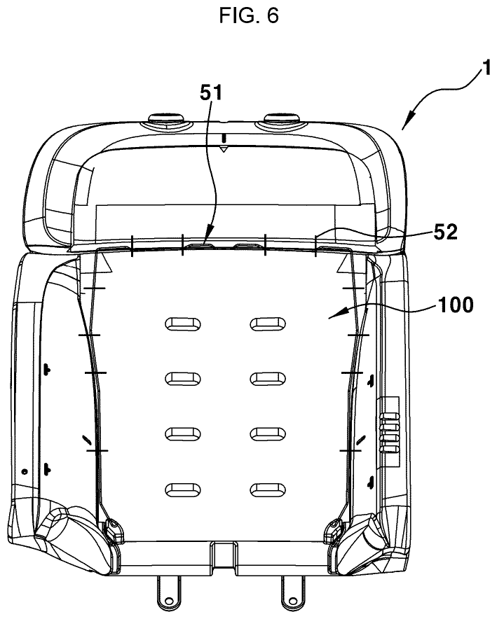

FIG. 6 is a view for description of the position at which a wire according to an embodiment of the present disclosure is disposed in the seatback.

Referring to FIGS. 4 to 6, the edges of the first air pocket 110 and the second air pocket 120 may be fixed to the seatback pad 10. A wire 51 may be disposed in the seatback pad 10. The wire 51 may be disposed to surround the edges of the first air pocket 110 and the second air pocket 120. For example, the wire 51 may be disposed in a space between the seatback pad 10 and the air pocket 100. A plurality of hog rings 52 may be provided along the edges of the first air pocket 110 and the second air pocket 120. The hog rings 52 may be connected to the wire 51.

According to the embodiment of the present disclosure, the edges of the first air pocket 110 and the second air pocket 120, which are portions to which air is not injected, may be fixed to the seatback pad 10, and portions of the first air pocket 110 and the second air pocket 120, into which air is injected, may not be connected or fixed to any component including the seatback pad 10. Accordingly, even if the massage module (not shown) is operated, the first air pocket 110 and the second air pocket 120 from which air is discharged may protrude toward the back of the passenger without being damaged. In other words, a central portion of each of the air pockets 110 and 120 may be configured to be freely pushed toward the back of the passenger by the massage module (not shown).

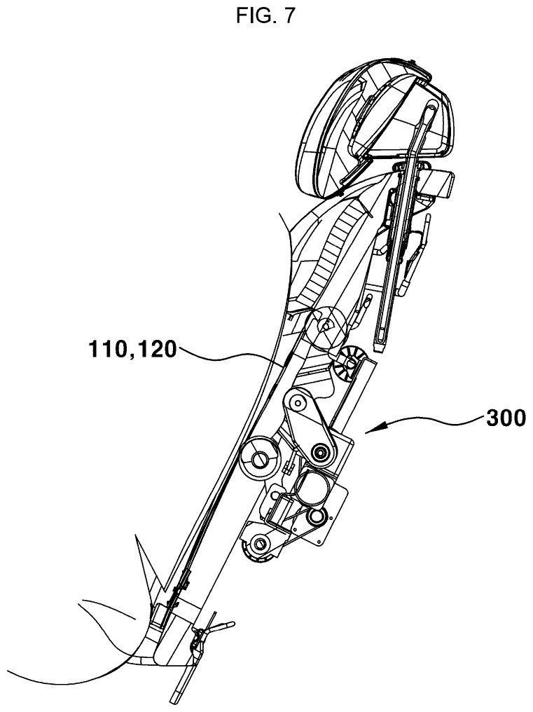

FIG. 7 is a view showing the air pocket in a state in which the massage module according to the embodiment of the present disclosure is activated.

Referring to FIGS. 4 and 7, a massage module 300 configured to massage the back of the passenger may be applied to the seatback 1. The massage module 300 may massage the back of the passenger by striking or rubbing the back of the passenger using a roller. The massage module 300 may be disposed on the second air pocket 120. In other words, the massage module 300 may be disposed at a position facing the first air pocket 110 with the second air pocket 120 interposed therebetween. Further, the massage module 300 may be in direct contact with the second air pocket 120. A direction opposite to a direction in which the massage module 300 faces the second air pocket 120 may be the rearmost portion of the seatback, and a separate board (not shown) or a vehicle frame may be provided at the rearmost portion of the seatback.

When the massage module 300 is activated, the amount of air injected into the first air pocket 110 and the second air pocket 120 may be controlled to a preset minimum value. For example, when the amount of air injected into the first air pocket 110 and the second air pocket 120 reaches the preset minimum value, the thickness of the first air pocket 110 and the second air pocket 120 may be reduced to 2 mm to 4 mm. The smaller the amount of air injected into the first air pocket 110 and the second air pocket 120, the more efficiently massage may be performed on the back of the passenger through the massage module 300. Furthermore, since the amount of air injected into the first air pocket 110 and the second air pocket 120 is controlled, an intensity level of massage performed on the back of the passenger may be controlled through the massage module 300. For example, when the amount of air injected into the first air pocket 110 and the second air pocket 120 is increased from the preset minimum value, the intensity level of massage performed on the back of the passenger through the massage module 300 may be reduced. Meanwhile, the massage module 300 may have an intensity adjustment function applied thereto.

According to the embodiment of the present disclosure, the amount of air injected into the first air pocket 110 and the second air pocket 120 may be controlled to be maximally reduced such that interference between the massage module 300 and the back of the passenger is maximally reduced, thereby increasing massage efficiency of the massage module 300. In addition, the intensity level of massage through the massage module 300 may be adjusted according to the amount of air injected into the first air pocket 110 and the second air pocket 120.

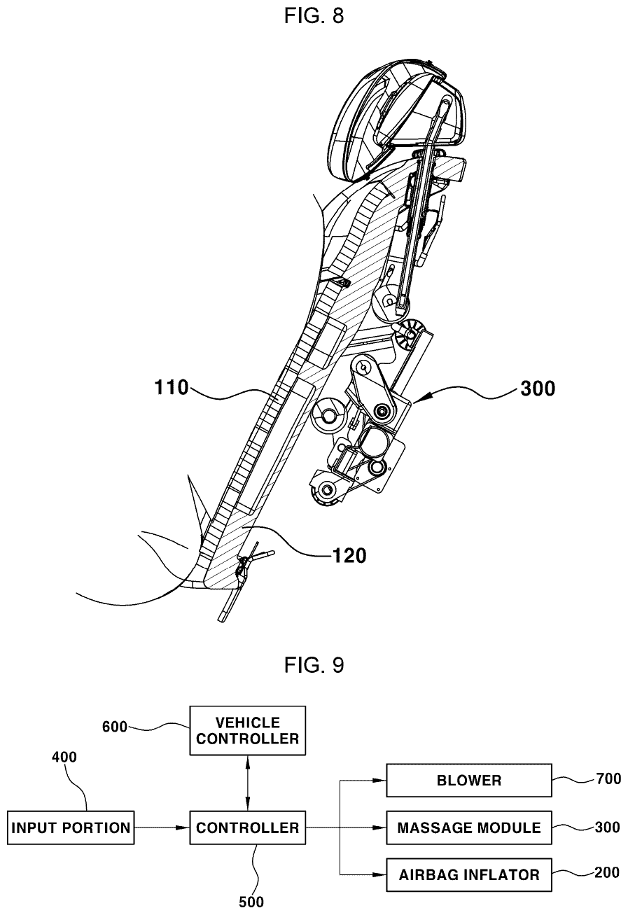

FIG. 8 is a view showing the air pocket in a state in which the massage module according to the embodiment of the present disclosure is not activated.

Referring to FIGS. 4 and 8, except a case in which the massage module 300 is activated, a larger amount of air than the preset minimum value may be injected into the first air pocket 110 and the second air pocket 120. That is, in a state in which the massage module 300 is not activated, air may be injected into the first air pocket 110 and the second air pocket 120 to support the back of the passenger.

For example, in a state in which the massage module 300 is not activated, the amount of air injected into the first air pocket 110 and the second air pocket 120 may be controlled to reach a preset average value. The preset average value may be a greater value than the preset minimum value. For example, when the amount of air, adjusted to the preset average value, is injected into the first air pocket 110 and the second air pocket 120, the thickness of the first air pocket 110 and the second air pocket 120 may be 30 mm to 40 mm. Accordingly, when an amount of air corresponding to the average value, which means an amount of air desired by a passenger, is injected into the first air pocket 110 and the second air pocket 120, the back of the passenger may be supported by the first air pocket 110 and the second air pocket 120 instead of a general pad. The passenger may control the amount of air injected into the first air pocket 110 and the second air pocket 120, thereby easily implementing seating comfort desired by the passenger.

For example, when vehicle collision is predicted or when vehicle collision occurs, the airbag inflator 200 may be operated. When the airbag inflator 200 is operated, the first air pocket 110 and the second air pocket 120 may be rapidly inflated. In this case, the massage module 300 may be moved in a direction away from the back of the passenger. Therefore, in the event of vehicle collision, it is possible to prevent injury to the back of the passenger due to the massage module 300 through maximum inflation of the first air pocket 110 and the second air pocket 120.

FIG. 9 is a view for description of a function of a controller according to an embodiment of the present disclosure.

Referring to FIG. 4 and FIG. 7 to FIG. 9, a controller 500 may control the amount of air injected into the first air pocket 110 and the second air pocket 120. Specifically, the controller 500 may control the amount of air injected into the first air pocket 110 and the second air pocket 120 based on whether the massage module 300 is activated by input from an input portion 400 and whether a signal regarding vehicle collision is received from a vehicle controller 600. For example, the input portion 400 may include a device configured to control the seat or the massage module 300 or an infotainment system configured to control components mounted in the vehicle.

For example, the vehicle controller 600 may be a vehicle control unit (VCU) configured to perform control related to driving and safety of the vehicle. The vehicle controller 600 may predict collision with an adjacent vehicle or may detect collision with an adjacent vehicle through sensors attached to the vehicle. The vehicle controller 600 may transmit, to the controller 500, a signal indicating that collision with an adjacent vehicle is predicted or a signal indicating that collision with an adjacent vehicle has occurred.

The input portion 400 may mean a component configured to input a user request to control a blower 700 for activation of a ventilation function of the seat and the massage module 300 for activation of a massage function of the seat. The passenger may control, through the input portion 400, the amount of air injected into the first air pocket 110 and the second air pocket 120 for the desired seating comfort.

The blower 700 may inject air into the first air pocket 110 and the second air pocket 120 or inject air into the inlet 127 of the second air pocket 120 for the ventilation function of the seat. According to the embodiment of the present disclosure, one blower 700 may be applied to the seatback, and a valve (not shown) may be provided on a duct (not shown) connected to the first line 119, the second line 129, and the inlet 127 so as to allow air discharged from the blower 700 to be injected into at least one of the first air pocket 110, the second air pocket 120, or the inlet 127.

The controller 500 may control the blower 700, the massage module 300, and the airbag inflator 200 based on signals input from the input portion 400 and the vehicle controller 600.

For example, when the massage module 300 is not activated, the controller 500 may perform control such that the amount of air injected into the first air pocket 110 and the second air pocket 120 is maintained at the preset average value. When the average value of air is injected into the first air pocket 110 and the second air pocket 120, the first air pocket 110 and the second air pocket 120 may support the back of the passenger. The passenger may adjust, depending on the desired seating comfort, the average value of air injected into the first air pocket 110 and the second air pocket 120. The controller 500 may control the blower 700 according to the average value of air, which is input in advance through the input portion 400, so as to inject air into the first air pocket 110 and the second air pocket 120.

For example, when the massage module 300 is activated, the controller 500 may perform control such that the amount of air injected into the first air pocket 110 and the second air pocket 120 is maintained at the preset minimum value. The controller 500 may stop the operation of the blower 700 and may discharge the air injected into the first air pocket 110 and the second air pocket 120. The controller 500 may discharge the air injected into the first air pocket 110 and the second air pocket 120 for a predetermined time or may discharge the air injected into the first air pocket 110 and the second air pocket 120 until the amount of air injected into the first air pocket 110 and the second air pocket 120 reaches the preset minimum value. Here, a sensor capable of measuring the amount of injected air or discharged air may be mounted on lines through which air is injected into the first air pocket 110 and the second air pocket 120 or air is discharged from the first air pocket 110 and the second air pocket 120.

For example, when a request for lowering an intensity level of the massage module 300 is input, the controller 500 may increase the amount of air injected into the first air pocket 110 and the second air pocket 120 above the preset minimum value. As the amount of air injected into the first air pocket 110 and the second air pocket 120 increases, the thickness of the first air pocket 110 and the second air pocket 120 increases such that the pressure of the massage module 300 to press the back of the passenger may decrease. Thereafter, when the passenger controls the input portion 400 to increase the intensity level of the massage module 300, the controller 500 may discharge a part of the air injected into the first air pocket 110 and the second air pocket 120. That is, the thickness of the first air pocket 110 and the second air pocket 120 decreases such that the pressure of the massage module 300 to press the back of the passenger may increase. As a result, the controller 500 may adjust the amount of air injected into the first air pocket 110 and the second air pocket 120 in response to a request for the massage intensity level input through the input portion 400. Meanwhile, the massage module 300 may have an intensity adjustment function applied thereto.

For example, the controller 500 may operate the airbag inflator 200 based on a vehicle collision signal received from the vehicle controller 600. When vehicle collision is predicted or vehicle collision occurs, the vehicle controller 600 may transmit a signal to the controller 500. The controller 500 may operate the airbag inflator 200 based on the received signal. Accordingly, the first air pocket 110 and the second air pocket 120 may be filled with air instantaneously. When air is rapidly injected into the first air pocket 110 and the second air pocket 120, the massage module 300 may be pushed in a direction away from the back of the passenger, and the massage module 300 may not directly hit the back of the passenger due to a distance between the massage module 300 and the back of the passenger, thereby preventing injury to the passenger in the event of vehicle collision.

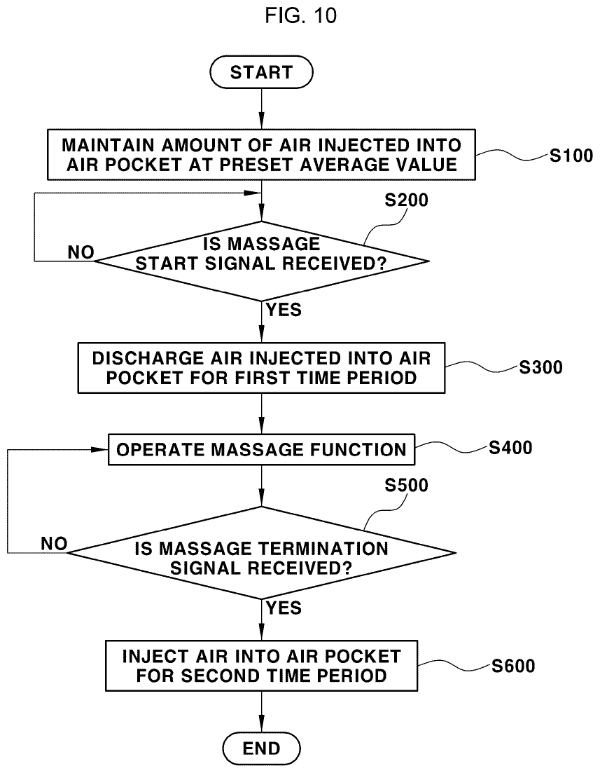

FIG. 10 is a view for description of a method of controlling the air pocket according to the embodiment of the present disclosure.

Referring to FIG. 10, the controller may control the blower and the air pocket so as to maintain the amount of air corresponding to the preset average value in the air pocket. Specifically, the controller may control the blower so as to inject the amount of air corresponding to the preset average value into the air pocket (S100).

The passenger may operate the massage module through the input portion. The controller may receive a massage start signal through the input portion (S200).

When the massage module is activated, the controller may discharge the air injected into the air pocket for efficient massage. Specifically, the controller may discharge the air injected into the air pocket for a first time period during which the amount of air injected into the air pocket reaches the preset minimum value from the preset average value. However, when the passenger adjusts an intensity level of a massage mode through the input portion, the controller may discharge the air injected into the air pocket based on a set value according to a request from the passenger. That is, the first time period may vary depending on a preset intensity level of the massage module. In this case, as the preset intensity level becomes lower, the first time period may become shorter. When the first time period becomes shorter, the amount of air injected into the air pocket may be larger than that corresponding to the average value. When the passenger sets the massage mode to the highest intensity level, a set amount, which is an amount of air injected into the air pocket according to a request from the passenger, may be the preset minimum value. When the passenger sets the massage mode to the lowest intensity level, a set amount, which is an amount of air injected into the air pocket according to a request from the passenger, may be larger than the preset minimum value or equal to the average value.

For example, when the massage mode is set to the highest intensity level, the first time period during which the amount of air injected into the air pocket reaches the preset minimum value from the preset average value may be 20 seconds. For example, when the massage mode is set to a moderate intensity level, the first time period during which the amount of air injected into the air pocket reaches a preset setting value from the preset average value may be 10 seconds. For example, when the massage mode is set to the lowest intensity level, the amount of air injected into the air pocket may be maintained at the preset average value, so the first time period may be 0 seconds (S300).

When the amount of air injected into the air pocket reaches the minimum value, the controller may stop discharging the air injected into the air pocket. Thereafter, the controller may control the massage module to operate the massage function (S400).

The controller may receive a massage termination signal according to a termination mode preset in the massage module or a massage termination request from the passenger. In other words, the massage module may perform the massage operation until the termination mode preset in the massage module is reached or the massage termination request from the passenger is input to the input portion (S500). The controller may inject air into the air pocket for a second time period during which the amount of air injected into the air pocket reaches the preset average value from the preset minimum value. For example, the second time period may be longer than the first time period. However, when the passenger adjusts the intensity level of the massage mode in advance through the input portion, the controller may inject air into the air pocket according to a set value in response to a request from the passenger. That is, the second time period may vary depending on the preset intensity level of the massage module. Here, the second time period may become shorter as the preset intensity level becomes lower. When the passenger sets the massage mode to the highest intensity level, the controller may inject air into the air pocket for the second time period during which the amount of air injected into the air pocket reaches the average value from the minimum value. When the passenger sets the massage mode to the lowest intensity level, the controller may inject air into the air pocket for the second time period so as to supplement the amount of air discharged by pressure applied to the air pocket during the massage operation.

For example, when the massage mode is set to the highest intensity level, the second time period during which the amount of air injected into the air pocket reaches the preset average value from the preset minimum value may be 30 seconds. For example, when the massage mode is set to the moderate intensity level, the second time period during which the amount of air injected into the air pocket reaches the preset average value from the preset setting value may be 20 seconds. For example, when the massage mode is set to the lowest intensity level, the amount of air injected into the air pocket may be approximately equal to the amount of air discharged by pressure applied to the air pocket during the massage operation. In this case, the second time period may be 5 seconds. That is, after the massage is finished, air may be injected into the air pocket to support the back of the passenger. In this case, a time period during which air is injected into the air pocket may vary in consideration of the amount of air discharged from the air pocket during the massage mode (S600).

As is apparent from the above description, the present disclosure provides the following effects.

According to the embodiment of the present disclosure, since a component supporting the back of a passenger is replaced with an air pocket, seating comfort desired by the passenger may be easily implemented by controlling the amount of air injected into the air pocket.

According to the embodiment of the present disclosure, a pad supporting the back of a passenger may be replaced with an air pocket, and ventilation performance of a seat may be implemented through ventilation holes and a flow path formed in the air pocket.

According to the embodiment of the present disclosure, since the amount of air injected into a first air pocket and a second air pocket is maximally reduced, interference between a massage module and the back of a passenger may be maximally reduced, thereby increasing efficiency of massage. In addition, a massage intensity level through the massage module may be adjusted depending on the amount of air injected into the first air pocket and the second air pocket.

According to the embodiment of the present disclosure, when vehicle collision is predicted or when vehicle collision occurs, a first air pocket and a second air pocket disposed between a massage module and the back of a passenger are maximally inflated, thereby preventing injury to the back of the passenger due to the massage module.

While embodiments of the present disclosure have been described with reference to the accompanying drawings, it will be appreciated by those skilled in the art to which the present disclosure pertains that the present disclosure may be implemented in other specific forms without departing from the principles and spirit of the disclosure, the scope of which is defined in the appended claims and equivalents thereto. Therefore, the embodiments described above should be understood as illustrative in all respects and should not be considered limiting.

What is claimed is:

1. A seatback comprising:
a seatback cover;
a seatback pad configured to support the seatback cover, the seatback pad including an open space formed therein;
a first air pocket disposed in the open space, the first air pocket including a plurality of ventilation holes provided therein; and
a second air pocket disposed on the first air pocket, the second air pocket including a flow path provided thereon, the flow path configured to be in communication with the ventilation holes.

2. The seatback of claim 1, wherein:
the flow path is provided on a first surface of the second air pocket,
the second air pocket includes an inlet provided on a second surface thereof, and
wherein air is to be injected into the flow path through the inlet, and
the first surface of the second air pocket is oriented to face the first air pocket.

3. The seatback of claim 1, wherein the first air pocket and the second air pocket are made of thermoplastic polyurethane or polyvinyl chloride.

4. The seatback of claim 1, comprising:
a massage module disposed on the second air pocket; and
a controller configured to control an amount of air injected into the first air pocket and the second air pocket.

5. The seatback of claim 4, wherein the controller is configured to, based on the massage module being activated, control the amount of the air injected into the first air pocket and the second air pocket to a preset minimum value.

6. The seatback of claim 5, wherein the controller is configured to, in response to input of a request to lower an intensity level of the massage module, control the amount of the air injected into the first air pocket and the second air pocket to be increased above the preset minimum value.

7. The seatback of claim 4, wherein the controller is configured to, based on the massage module being in a non-activated state, control the amount of the air injected into the first air pocket and the second air pocket to be maintained at a preset average value.

8. The seatback of claim 4, comprising an airbag inflator provided between the first air pocket and the second air pocket,
wherein the controller is configured to operate the airbag inflator based on a vehicle collision signal received from a vehicle controller.

9. The seatback of claim 1, further comprising:
a wire connected to the seatback pad; and
a plurality of hog rings configured to connect the first air pocket and the second air pocket to the wire.

10. The seatback of claim 1, further comprising a blower configured to inject air into the first air pocket, the second air pocket, and the flow path.

11. A seatback comprising:
a seatback cover;
a seatback pad configured to support the seatback cover, the seatback pad including an open space formed therein;
an air pocket disposed in the open space of the seatback pad, the air pocket configured to support a back of a passenger;
a massage module disposed on the air pocket; and
a controller configured to control an amount of air injected into the air pocket based on whether the massage module is activated.

12. The seatback of claim 11, wherein the air pocket includes:
a first air pocket disposed on a frame of the seatback, the first air pocket including a plurality of through-holes provided therein; and
a second air pocket disposed on the first air pocket, the second air pocket including a flow path provided thereon, the flow path configured to be in communication with the through-holes, and
wherein the first air pocket is disposed on a first surface of the second air pocket, and the massage module is disposed on a second other surface of the second air pocket, the second surface is opposite the first surface of the second air pocket.

13. The seatback of claim 11, wherein the controller is configured to, based on the massage module being in a non-activated state, control the amount of the air injected into the air pocket to be maintained at a preset average value.

14. The seatback of claim 13, wherein the controller is configured to, based on the massage module being activated, control the air injected into the air pocket to be discharged for a preset first time period.

15. The seatback of claim 14, wherein:
the preset first time period is set to vary depending on a preset intensity level of the massage module, and
the preset first time period is set to become shorter as the preset intensity level becomes lower.

16. The seatback of claim 14, wherein the controller is configured to, based on operation of the massage module being terminated, control the air injected into the air pocket for a preset second time period so as to adjust the amount of the air injected into the air pocket to the preset average value.
